(19) United States
(12) Patent Application Publication
(10) Pub. No.: US 2020/0301738 A1
(43) Pub. Date: Sep. 24, 2020

(54) POWER CONSUMPTION PREDICTION METHOD, POWER CONSUMPTION PREDICTION APPARATUS, AND NON-TRANSITORY COMPUTER-READABLE STORAGE MEDIUM FOR STORING POWER CONSUMPTION PREDICTION PROGRAM

(71) Applicant: FUJITSU LIMITED, Kawasaki-shi (JP)

(72) Inventors: Shigeto SUZUKI, Kawasaki (JP); Michiko Shiraga, Kawasaki (JP); Takashi Shiraishi, Atsugi (JP)

(73) Assignee: FUJITSU LIMITED, Kawasaki-shi (JP)

(21) Appl. No.: 16/805,961

(22) Filed: Mar. 2, 2020

(30) Foreign Application Priority Data
Mar. 22, 2019 (JP) 2019-054266

(51) Int. Cl. G06F 9/48; G06N 7/00; G06F 1/28

(52) U.S. Cl. CPC G06F 9/4893; G06F 1/28; G06N 7/005

(57) ABSTRACT

A power consumption prediction method includes: generating a first topic distribution indicating a word appearance probability for each topic in first information regarding a job executed in a past for each first information; generating a second topic distribution indicating a word appearance probability for each topic in second information regarding a prediction target job; generating a first normalized topic distribution; generating a second normalized topic distribution by converting the word appearance probability in the second topic distribution into a plurality of numeric values based on the predetermined rule; extracting the first normalized topic distribution most similar to the second normalized topic distribution among a plurality of the first normalized topic distributions; and predicting power consumption of the prediction target job based on power consumption when the job indicated by the first information corresponding to the extracted first normalized topic distribution is executed.

### CROSS-REFERENCE TO RELATED APPLICATION

This application is based upon and claims the benefit of priority of the prior Japanese Patent Application No. 2019-54266, filed on Mar. 22, 2019, the entire contents of which are incorporated herein by reference.

### FIELD

The embodiment discussed herein is related to a power consumption prediction method, a power consumption prediction apparatus, and a non-transitory computer-readable storage medium for storing a power consumption prediction program.

### BACKGROUND

In recent years, since performance of a high performance computer (HPC) is improved, power consumption when the HPC is used increases, and an electricity rate is being high. A contract electricity rate is decided based on a highest value of average power consumption in a predetermined period (for example, 30 minutes) in which power is most used in a previous year, for example. In this case, even when the highest value of the average power consumption in the previous year is exceeded once in one of a plurality of predetermined periods in a current fiscal year, the contract electricity rate for the following fiscal year increases.

As a related art technology, a technology has been proposed in which the same number of computers as the number of a plurality of computer operation processes are selected in ascending order of the electricity rate per unit calculation amount at the time of input, and allocated to computers selected for the plurality of computer operation processes.

As a related art technology, a facility has been proposed which includes a system configured to execute a plurality of jobs, and a memory that stores a code for managing power consumption in the facility and setting the power consumption to be in a range of a power band.

As a related art technology, a technology has been proposed for estimating an access to a storage device from a job in a predetermined time segment based on schedule information and history information, and controlling power supply to the storage device based on an estimation result.

As a related art technology, a technology has been proposed for obtaining actual power consumption of a single job in accordance with a similarity of a character string of a file used for the job, and estimating power consumption of the job based on the obtained actual power consumption.

As a related art technology, a technology has been proposed for applying an actual measurement value of performance information for each task to a prediction expression for power consumption, and calculating power consumption for each task.

Examples of the related art include Japanese Laid-open Patent Publication No. 2005-250823, Japanese National Publication of International Patent Application No. 2018-501580, Japanese Laid-open Patent Publication No. 2017-58710, Japanese Laid-open Patent Publication No. 2018-84907, and Japanese Laid-open Patent Publication No. 2015-179383.

### SUMMARY

According to an aspect of the embodiments, a power consumption prediction method implemented by a computer, the power consumption prediction method includes: generating a first topic distribution indicating a word appearance probability for each topic in first information regarding a job executed in a past for each first information; generating a second topic distribution indicating a word appearance probability for each topic in second information regarding a prediction target job; generating a first normalized topic distribution by converting the word appearance probability in the first topic distribution into a plurality of numeric values based on a predetermined rule; generating a second normalized topic distribution by converting the word appearance probability in the second topic distribution into a plurality of numeric values based on the predetermined rule; extracting the first normalized topic distribution most similar to the second normalized topic distribution among a plurality of the first normalized topic distributions; and predicting power consumption of the prediction target job based on power consumption when the job indicated by the first information corresponding to the extracted first normalized topic distribution is executed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overview of a power consumption prediction method according to a related art technology;

FIG. 2 is a diagram illustrating an overview of a power consumption prediction method according to a present embodiment;

FIG. 3 is a diagram illustrating an example of a processing time of power consumption prediction according to the related art technology and the present embodiment;

FIG. 4 is a diagram illustrating an example of an overall configuration of a system according to the embodiment;

FIG. 5 is a diagram illustrating an example of a topic;

FIG. 6 is a diagram illustrating an example of normalization of a topic distribution of a past job;

FIG. 7 is a diagram illustrating an example of normalization of a topic distribution of a prediction target job;

FIG. 8 is a diagram illustrating an overview of a method for determining whether to execute topic generation;

FIG. 9 is a diagram illustrating a relationship between the number of created topics and a highest value of the number of allocated topics;

FIG. 10 is a diagram illustrating a flowchart illustrating an example of prediction process according to the embodiment;

FIG. 11 is a flowchart illustrating an example of topic generation process according to the embodiment; and

FIG. 12 is a diagram illustrating an example of a hardware configuration of a prediction apparatus.

### DESCRIPTION OF EMBODIMENT(S)

When a contract electricity rate is decided based on power consumption in a predetermined period in which power is most used in a previous year, it is conceivable to perform job scheduling to avoid increase in the electricity rate. For example, it is conceivable to perform the job scheduling such that the average power consumption in the predetermined period does not exceed a highest value in the previous year by predicting power consumption of a prediction target job based on power consumption of a job similar to the prediction target job among jobs executed in the past.

However, when a similarly between the job executed in the past and the prediction target job is calculated based on various information regarding the jobs, since the similarly calculation takes time, an issue occurs that it takes time to predict the power consumption of the job.

According to an aspect, the present disclosure aims at speeding up the power consumption prediction of the job.

According to the aspect, the power consumption prediction of the job may be sped up.

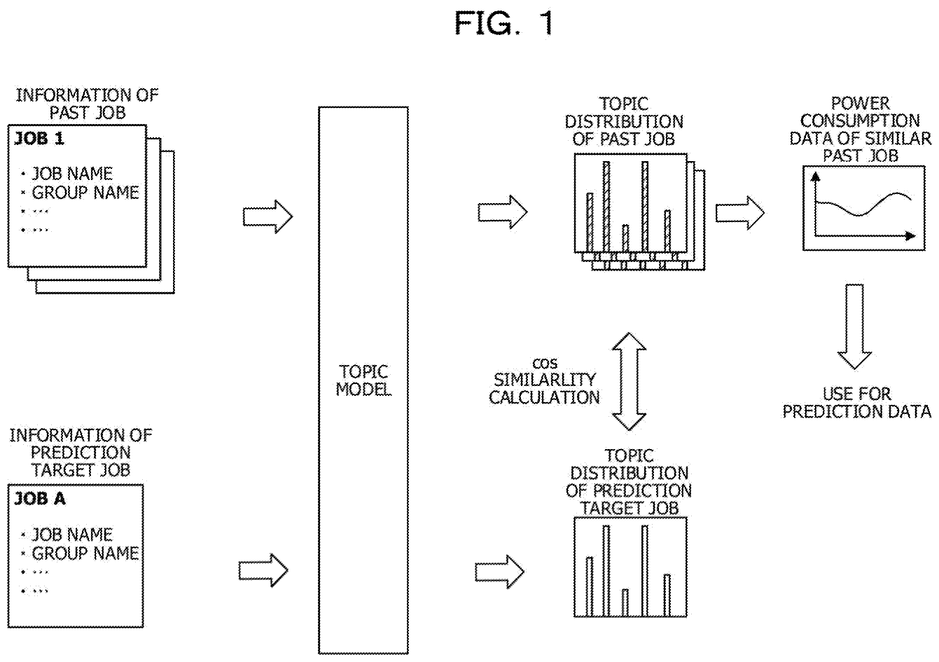

FIG. 1 is a diagram illustrating an overview of a power consumption prediction method according to a related art technology. An apparatus that performs power consumption prediction according to the related art technology (hereinafter, referred to as a prediction apparatus according to the related art technology) inputs information regarding a past job to a previously generated topic model and generates a topic distribution of the past job. The topic distribution indicates an appearance probability of a word in a topic in the input information. Similarly, the prediction apparatus according to the related art technology inputs information regarding a target job where power consumption is predicted (prediction target job) to a topic model and generates a topic distribution of the prediction target job.

The prediction apparatus according to the related art technology searches for a topic distribution most similar to the topic distribution of the prediction target job among topic distributions of past jobs. At this time, the prediction apparatus according to the related art technology calculates a cosine similarity (cos similarity) for each topic in the topic distribution and sets a total of cos similarities as a similarity of the topic distribution. Power consumption data of the past job corresponding to a generation source of the topic distribution most similar to the topic distribution of the prediction target job is used as power consumption prediction data of the prediction target job.

For example, a similarity S_{kk′} between a topic k and a topic k′ is calculated as in Expression (1) using a vector space method. That is, for example, the similarity S_{kk′} is represented by a cosine of an appearance vector of nₖ (nₖ₁, . . . , nₖᵥ, . . . ,) of a vocabulary v for each topic.

$${S}_{kk ′} = \frac{{n}_{k} \cdot {n}_{k ′}}{\vert {n}_{k} \vert \vert {n}_{k ′} \vert} \qquad ( 1 )$$

However, when the power consumption of the prediction target job is predicted using the example illustrated in FIG. 1, since the calculation amount of the cos similarity calculation is high, it takes time to perform prediction process for the power consumption of the prediction target job.

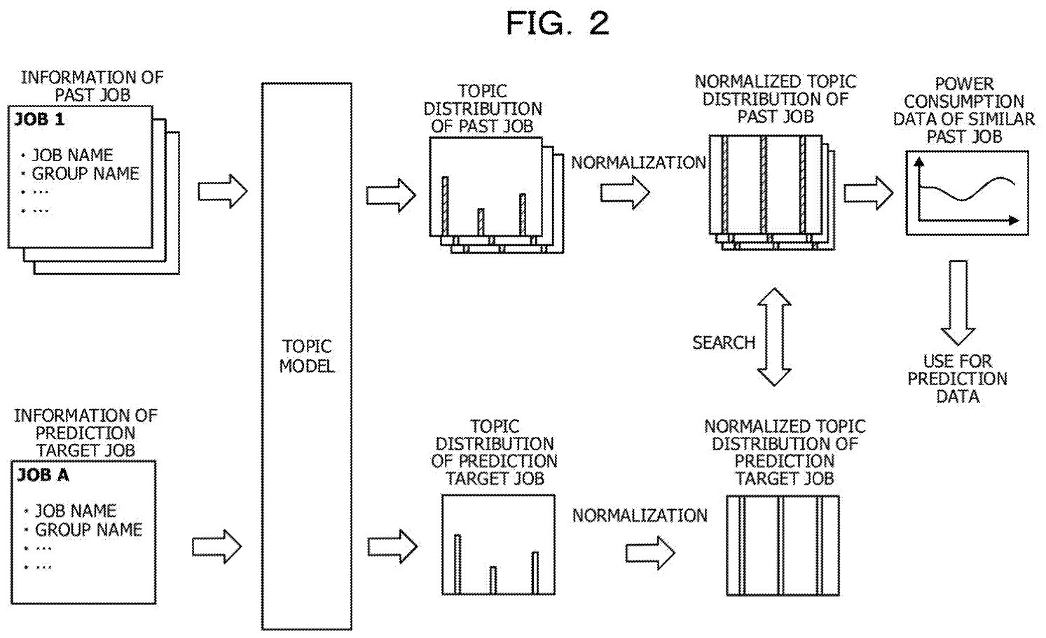

FIG. 2 is a diagram illustrating an overview of a power consumption prediction method according to a present embodiment. An apparatus that performs power consumption prediction according to present embodiment (hereinafter, referred to as a prediction apparatus according to the present embodiment) inputs information regarding a past job to a previously generated topic model and generates a topic distribution of the past job. Similarly, the prediction apparatus according to the present embodiment inputs information regarding a target job where power consumption is predicted (prediction target job) to a topic model and generates a topic distribution of the prediction target job.

The prediction apparatus according to the present embodiment respectively normalizes the topic distribution of the past job and the topic distribution of the prediction target job into distributions using a plurality of numeric values (0 or 1). For example, the prediction apparatus according to the present embodiment does not convert a word appearance probability when the word appearance probability in the topic distribution is 0, and converts the word appearance probability into 1 when the word appearance probability in the topic distribution is other than 0. That is, for example, the plurality of numeric values are two numeric values, but may be three or more numeric values. The prediction apparatus according to the present embodiment searches for a topic distribution most similar to the topic distribution of the prediction target job among normalized topic distributions of the past jobs. At this time, the prediction apparatus according to the present embodiment does not perform the cos similarity calculation but performs determination as to whether or not word appearance probabilities of respective topics are matched for each topic, and extracts the normalized topic distribution of the past job which has the highest number of matched topics. The prediction apparatus according to the present embodiment uses power consumption data of the past job corresponding to a generation source of the extracted normalized topic distribution as power consumption prediction data of the prediction target job.

According to the method illustrated in FIG. 2, since the cos similarity calculation is not performed, as compared with the method illustrated in FIG. 1, the calculation amount is low, and the power consumption prediction of the prediction target job may be sped up.

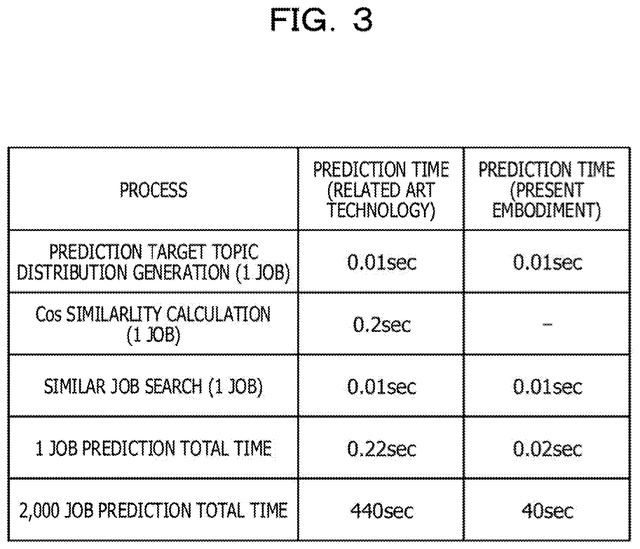

FIG. 3 is a diagram illustrating an example of a processing time of power consumption prediction according to the related art technology and the present embodiment. FIG. 3 illustrates an example of the processing time when the power consumption prediction is performed based on the power consumption prediction method according to the related art technology illustrated in FIG. 1 and the power consumption prediction method according to the present embodiment illustrated in FIG. 2. As illustrated in FIG. 3, the processing time is the same for the topic distribution generation and the similar job search, but the cos similarity calculation takes much time according to the related art technology. As a result, the prediction apparatus according to the present embodiment completes the power consumption prediction in a shorter time period than that of the prediction apparatus according to the related art technology.

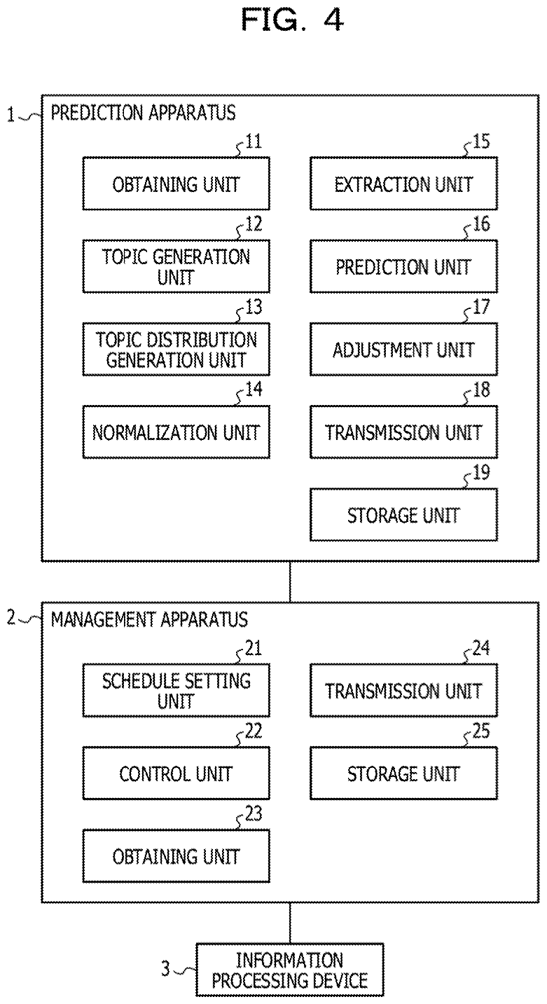

FIG. 4 illustrates an example of an overall configuration of a system according to the embodiment. The system according to the embodiment includes a prediction apparatus 1 that predicts power consumption when a job is executed by an information processing apparatus 3, a management apparatus 2 that manages information processing apparatus 3, and the information processing apparatus 3 that executes the job. The prediction apparatus 1 is an example of a computer. The prediction apparatus 1 and the management apparatus 2 are, for example, a server, a personal computer, or the like. The information processing apparatus 3 is, for example, an HPC or a general-use computer, or the like. The prediction apparatus 1 is coupled to the management apparatus 2 via, for example, a communication network, such as a local area network (LAN) or a wide area network (WAN). The management apparatus 2 is coupled to the information processing apparatus 3 via a communication network such as the LAN or the WAN.

The prediction apparatus 1 includes an obtaining unit 11, a topic generation unit 12, a topic distribution generation unit 13, a normalization unit 14, an extraction unit 15, a prediction unit 16, an adjustment unit 17, a transmission unit 18, and a storage unit 19.

The obtaining unit 11 obtains information (first information) regarding a job executed by the information processing apparatus 3 in the past and information indicating power consumption when the job is executed from the management apparatus 2 to be stored in the storage unit 19. The job executed by the information processing apparatus 3 in the past is a job executed in the last one month, for example. The information indicating the power consumption is time-series data of power consumption for each executed job, for example. Hereinafter, the job executed by the information processing apparatus 3 in the past may be referred to as a past job in some cases. A plurality of past jobs exist, and the first information exists for each past job.

The obtaining unit 11 obtains information (second information) regarding a target job where power consumption is predicted to be stored in the storage unit 19. Hereinafter, the target job where the power consumption is predicted is referred to as a prediction target job. The prediction target job is a job expected to be executed, for example.

The first information and the second information include, for example, a job name, a group name to which the job belongs, a maximum execution time period, a priority order, a job input time, and the like.

The topic generation unit 12 generates one or a plurality of topics from words included in the first information obtained by the obtaining unit 11, generates a topic model used for generating a topic distribution using the topics, and stores the topics and the topic model in the storage unit 19.

For example, the topic generation unit 12 extracts words respectively existing in plural first information by morphologic analysis or the like and counts the words appearing in the respective first information. The topic generation unit 12 performs grouping of words having high probabilities to appear in the same first information to be set as a topic. The following Expression 2 is a sampling expression of a topic z_{d,n} regarding a word w_{d,n} in a document d (first information). That is, for example, a right side of Expression 2 is a value proportional to a probability that a word in a topic appears in a single document and referred to as a word appearance probability according to the present embodiment.

$$p ( {z}_{d , n} = k \vert {w}_{d , n} = v , {w}^{\backslash d , n} , {z}^{\backslash d , n} , α , β ) ∝ \frac{{N}_{k , v}^{\backslash d , n} + β}{{N}_{k}^{\backslash d , n} + β V} ( {N}_{d , k}^{\backslash d , n} + α ) \qquad ( 2 )$$

In Expression 2, p denotes a probability, n denotes an index of a word, k denotes an index of a topic, v denotes an index of a vocabulary, α denotes a hyperparameter of a topic distribution, and denotes a hyperparameter of a word distribution. V denotes an all word vocabulary (types of words included in a document set), and \ denotes a difference from a set. N_{d,k} denotes the number of times when the topic k is allocated to the document d, Nₖ denotes the number of times when the topic k is allocated to the document set, and N_{k,v}, denotes the number of times when the topic k is allocated to the vocabulary v. The topic generation unit 12 calculates Expression 2 regarding respective documents and respective words and generates a topic such that a value indicated by the right side of Expression 2 becomes high. The number of generated topics is previously set as a predetermined number and periodically adjusted by processing of the adjustment unit 17 described below. The topic generation unit 12 generates a topic model used for generating a topic distribution by using the generated topic.

The topic distribution generation unit 13 generates a first topic distribution for each first information which indicates the word appearance probability for each topic in the first information by using the generated topic model. The topic distribution generation unit 13 generates a second topic distribution indicating the word appearance probability for each topic in the second information by using the generated model. The word appearance probability is a ratio of a word included in the first information among words in a certain topic. When at least one word in the generated topic exists in the first information, the topic distribution generation unit 13 allocates the number of topics to the first information.

The normalization unit 14 generates a first normalized topic distribution obtained by converting the word appearance probability in the first topic distribution into a plurality of numeric values based on a predetermined rule. For example, the normalization unit 14 does not perform the conversion when the word appearance probability is 0, but converts the word appearance probability into 1 when the word appearance probability is other than 0. That is, for example, the normalization unit 14 converts the word appearance probability into two numeric values of 0 and 1. The normalization unit 14 similarly generates a second normalized topic distribution obtained by converting the word appearance probability in the second topic distribution into a plurality of numeric values based on the predetermined rule. The rule used for generating the first normalized topic distribution is the same as the rule used for generating the second normalized topic distribution.

The extraction unit 15 extracts the first normalized topic distribution most similar to the second normalized topic distribution among a plurality of the first normalized topic distributions. The first normalized topic distribution most similar to the second normalized topic distribution includes the first normalized topic distribution that is same as the second normalized topic distribution. Determination is performed as to whether or not the word appearance probability of each topic in the plurality of the first normalized topic distributions is matched with the word appearance probability of each topic in the second normalized topic distribution. The extraction unit 15 extracts the first normalized topic distribution having the highest number of matched topics.

The prediction unit 16 obtains time-series data of power consumption when the job indicated by the first information corresponding to the first normalized topic distribution extracted by the extraction unit 15 is executed from storage unit 19, and predicts power consumption of the prediction target job based on the data. The prediction unit 16 may apply the aforementioned time-series data of power consumption obtained from the storage unit 19 to the power consumption prediction data of the prediction target job as it is.

The topic generation unit 12 periodically generates one or a plurality of topics (first topics) from words included in the first information and a topic model using the first topics. The topic generation unit 12 periodically generates one or a plurality of topics (second topics) from words that are not included in the generated first topics among the words included in the first information and a topic model using the second topics.

The topic distribution generation unit 13 generates the topic distribution by using the topic model using the first topic as the first information, and generates the topic distribution by using the topic model using the second topic as the first information. When at least one word in any topic among one or a plurality of generated first topics exists in the first information, the topic distribution generation unit 13 allocates any of the topics to the first information. Similarly, when at least one word in any topic among one or a plurality of generated second topics exists in the first information, the topic distribution generation unit 13 allocates any of the topics to the first information.

When the highest value of the number of topics allocated to the first information among the first topics is lower than the highest value of the number of topics allocated to the first information among the second topics, the adjustment unit 17 adjusts the number of topics used for topic generation. As described above, the second topic is the topic generated from the words that are not included in the generated first topic among the words included in the first information. Therefore, when the highest value of the number of topics allocated to the first information among the first topics is lower than the highest value of the number of topics allocated to the first information among the second topics, it is considered that the topic is not appropriate, and the number of topics when the topic is generated is preferably adjusted.

After the number of topics is adjusted, the topic generation unit 12 generates the adjusted number of topics from the words included in the first information obtained by the obtaining unit 11, and generates a topic model using the topics to be stored in the storage unit 19. The topic distribution generation unit 13 generates the topic distribution using the latest topic model stored in the storage unit 19.

When the number of topics is adjusted, the adjustment unit 17 adjusts the number of topics used for generating the topic such that the number of topics allocated to the first information becomes a predetermined number (for example, 3). This is because, as the number of topics allocated to the first information becomes higher, it becomes difficult for the extraction unit 15 to extract the similar topic distribution when the first normalized topic distribution is compared with the second normalized topic distribution.

The transmission unit 18 transmits the prediction data of the power consumption predicted by the prediction unit 16 to the management apparatus 2. The storage unit 19 stores the information (first information) regarding the job executed in the past and the information indicating the power consumption when the job is executed which are obtained by the obtaining unit 11. The storage unit 19 stores the topic and the topic model generated by the topic generation unit 12.

The management apparatus 2 includes a schedule setting unit 21, a control unit 22, an obtaining unit 23, a transmission unit 24, and a storage unit 25.

The schedule setting unit 21 performs schedule setting of the job executed by the information processing apparatus 3 based on the power consumption prediction data transmitted from the prediction apparatus 1 such that a power consumption average value in a predetermined period (for example, 30 minutes) does not exceeds a threshold. The threshold is, for example, a highest value of a power consumption average value in a predetermined period in a previous year. For example, when a contract electricity rate is decided based on the highest value in the previous year of the power consumption average value in the predetermined period, increase in the contract electricity rate may be avoided when the schedule setting unit 21 sets such that the power consumption average value in the predetermined period does not exceed the highest value in the previous year.

The control unit 22 transmits a job execution instruction to the information processing apparatus 3 via the transmission unit 24 based on the schedule set by the schedule setting unit 21. The obtaining unit 23 obtains information regarding the executed job and information indicating a job execution time period and power consumption when the job is executed from the information processing apparatus 3.

The transmission unit 24 transmits the information indicating the job executed by the information processing apparatus 3 and the power consumption when the job is executed which is obtained by the obtaining unit 23 to the prediction apparatus 1. The storage unit 25 stores the power consumption prediction data transmitted from the prediction apparatus 1, the information indicating the job executed by the information processing apparatus 3 and the power consumption when the job is executed which is by the obtaining unit 23, and the like.

The information processing apparatus 3 executes the job following the job execution instruction received from the management apparatus 2. The information processing apparatus 3 transmits the information regarding the executed job and the information indicating the job execution time period and the power consumption when the job is executed to the management apparatus 2.

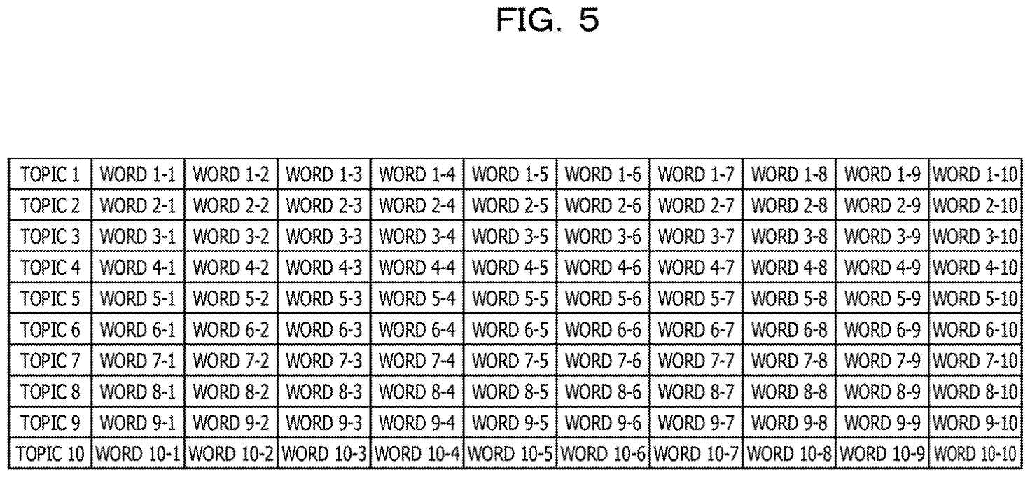

FIG. 5 is a diagram illustrating an example of the topic. As illustrated in FIG. 5, topics including a topic 1 to a topic 10 are generated by the topic generation unit 12 and stored in the storage unit 19. Each topic includes a plurality of words. The number of topics is not necessarily 10. The number of words in each topic may vary.

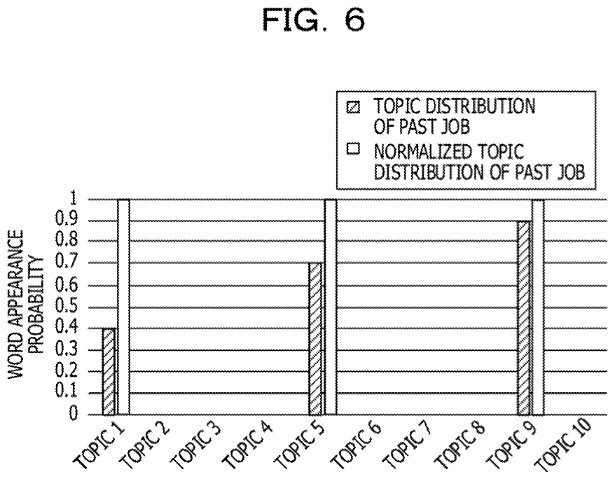

FIG. 6 is a diagram illustrating an example of normalization of the topic distribution of the past job. In the example illustrated in FIG. 6, the number of generated topics is 10. In the example illustrated in FIG. 6, the word appearance probability of the topic 1 in the topic distribution of the past job is 0.4, the word appearance probability of the topic 5 is 0.7, and the word appearance probability of the topic 9 is 0.9. The word appearance probability of the topic other than the topic 1, the topic 5, and the topic 9 is 0. In this case, the number of topics allocated to the first information is 3 (the topic 1, the topic 5, and the topic 9).

As described above, the normalization unit 14 converts the word appearance probability in the topic distribution of the past job into the plurality of numeric values based on the predetermined rule. For example, the normalization unit 14 does not perform the conversion when the word appearance probability is 0, but converts the word appearance probability into 1 when the word appearance probability is other than 0. The normalization unit 14 does not convert the word appearance probability of the topic other than the topic 1, the topic 5, and the topic 9, but converts the word appearance probability of the topic 1, the topic 5, and the topic 9 all into 1 based on the aforementioned predetermined rule.

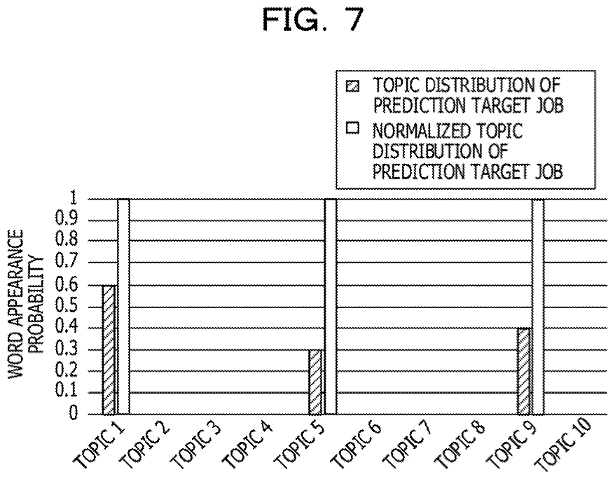

FIG. 7 is a diagram illustrating an example of normalization of the topic distribution of the prediction target job. In the example illustrated in FIG. 7, the number of generated topics is 10 similarly as in FIG. 6. In the example illustrated in FIG. 7, the word appearance probability of the topic 1 in the topic distribution of the prediction target job is 0.6, the word appearance probability of the topic 5 is 0.3, and the word appearance probability of the topic 9 is 0.4. The word appearance probability of the topic other than the topic 1, the topic 5, and the topic 9 is 0. In this case, the number of topics allocated to the first information is 3 (the topic 1, the topic 5, and the topic 9).

As described above, the normalization unit 14 converts the word appearance probability in the topic distribution of the past job into the plurality of numeric values based on the predetermined rule. The normalization unit 14 does not convert the word appearance probability of the topic other than the topic 1, the topic 5, and the topic 9, but converts the word appearance probability of the topic 1, the topic 5, and the topic 9 all into 1 based on the aforementioned predetermined rule.

As described above, the extraction unit 15 determinates whether or not the word appearance probability of each topic in the plurality of the first normalized topic distributions is matched with the word appearance probability of each topic in the second normalized topic distribution. When the examples in FIG. 6 and FIG. 7 are used, the topic distributions after the normalization are the same, and the first normalized topic distribution in FIG. 6 is extracted. Since the word appearance probability in the topic distribution after the normalization is 0 or 1, the comparison process of the word appearance probability takes a shorter time period as compared with a case where the cos similarity is calculated as in the example illustrated in FIG. 1.

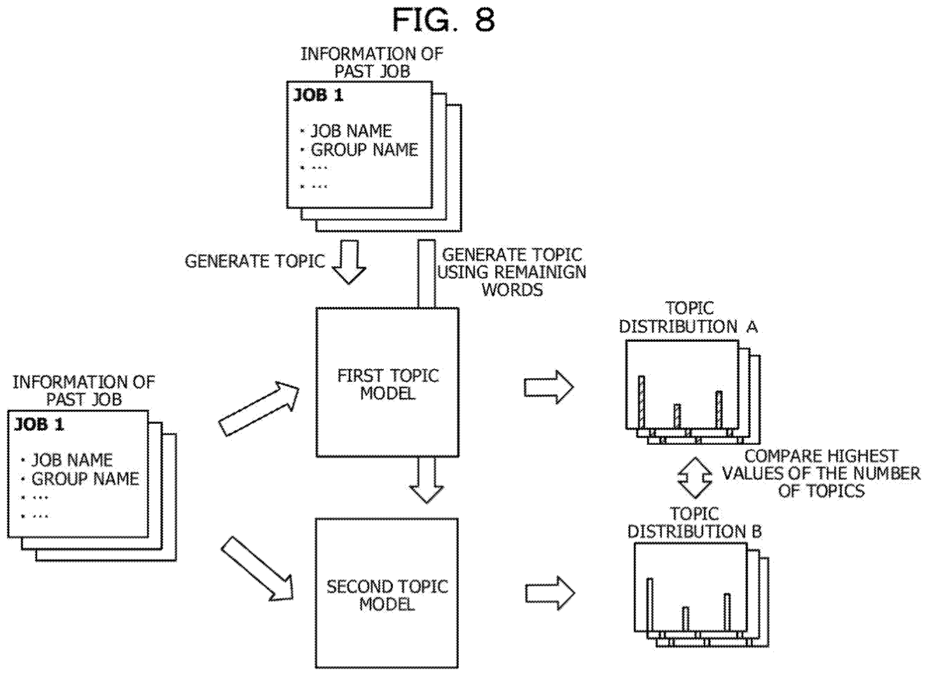

FIG. 8 is a diagram illustrating an overview of a method for determining whether to execute topic generation. The topic generation unit 12 periodically generates a topic (first topics) from the words included in the information (first information) regarding the past job and a topic model (first topic model) using the first topics. The topic generation unit 12 generates a topic (second topics) from the remaining words that are not included in the generated first topic among the words included in the first information and a topic model (second topic model) using the second topics. The topic distribution generation unit 13 generates a topic distribution (topic distribution A) using the first topic model as the first information, and generates a topic distribution (topic distribution B) using the second topic model as the first information.

The adjustment unit 17 refers to the topic distributions A and B and compares the highest value of the number of topics allocated to the first information among the first topics with the highest value of the number of topics allocated to the first information among the second topics. The number of topics allocated to the first information is the number of topics where the word appearance probability is other than 0 among the topic distributions, for example. When the highest value of the number of topics allocated to the first information among the first topics is lower than the highest value of the number of topics allocated to the first information among the second topics, the adjustment unit 17 adjusts the number of topics used for generating the topic. The topic generation unit 12 generates the adjusted number of topics from the words included in the first information, and generates a topic model using the topics to be stored in the storage unit 19.

When the highest value of the number of topics allocated to the first information among the first topics is lower than the highest value of the number of topics allocated to the first information among the second topics, it is considered that the topic is not appropriate. Therefore, when the prediction apparatus 1 adjusts the number of topics in the aforementioned case and generates the topic and the topic model again, accuracy for the power consumption prediction may be improved.

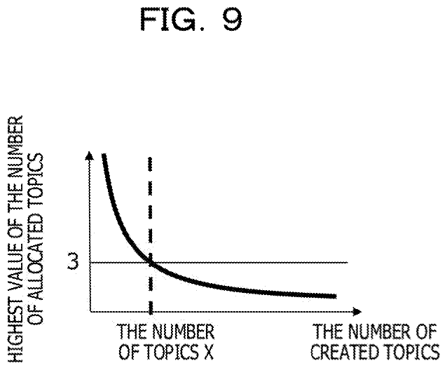

FIG. 9 is a diagram illustrating a relationship between the number of created topics and the highest value of the number of allocated topics. As illustrated in FIG. 9, as the number of generated topics is higher, the highest value of the number of topics allocated to the first information is increased when the topic distribution is generated. For this reason, when the number of topics is adjusted, the adjustment unit 17 starts the adjustment from a state where the number of generated topics is low, gradually increases the number of created topics, and adjusts the number of created topics such that the number of topics allocated to the first information becomes a predetermined number (for example, 3).

As the number of topics allocated to the first information becomes higher, it becomes difficult for the extraction unit 15 to extract the similar topic distribution when the first normalized topic distribution is compared with the second normalized topic distribution. Therefore, when the prediction apparatus 1 adjusts the number of generated topics such that the number of topics allocated to the first information becomes the predetermined number, it is facilitated to extract the similar topic distribution.

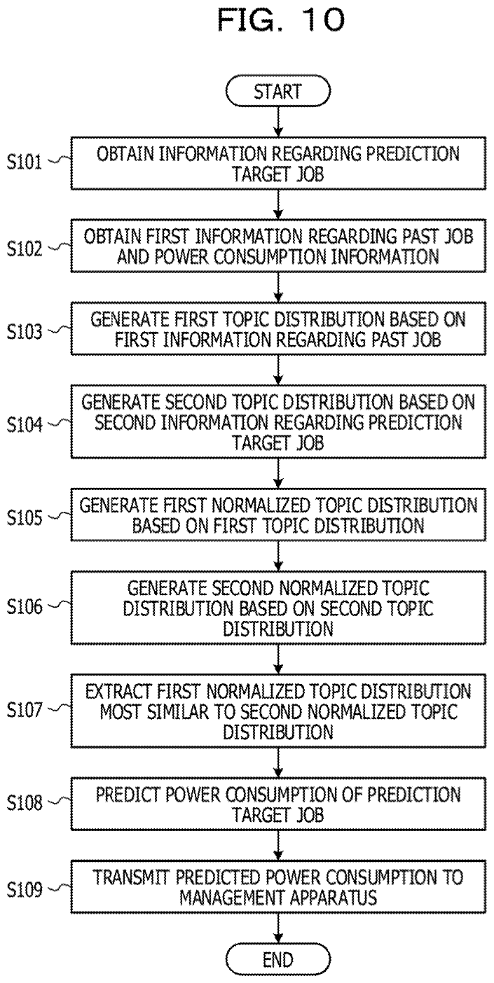

FIG. 10 is a flowchart illustrating an example of prediction process according to the embodiment. Before the process illustrated in FIG. 10, generation of the topic and the topic model by the topic generation unit 12 is performed at least once.

The obtaining unit 11 obtains information (second information) regarding the job of the power consumption prediction target (step S101). For example, the second information is transmitted from the management apparatus 2 in accordance with an instruction of a user. The prediction apparatus 1 may start the process illustrated in FIG. 10 by using the transmission of the second information as a trigger. The obtaining unit 11 obtains information (first information) regarding a job executed in the past and information indicating power consumption when the job is executed from the management apparatus 2 (step S102).

The topic distribution generation unit 13 generates a first topic distribution for each first information which indicates a word appearance probability for each topic in the first information by using the previously generated topic model (step S103). The topic distribution generation unit 13 generates a second topic distribution for each first information which indicates a word appearance probability for each topic in the second information by using the previously generated topic model (step S104).

The normalization unit 14 generates a first normalized topic distribution obtained by converting the word appearance probability in the first topic distribution into a plurality of numeric values based on a predetermined rule (step S105). The normalization unit 14 generates a second normalized topic distribution obtained by converting the word appearance probability in the second topic distribution into a plurality of numeric values based on a predetermined rule (step S106).

The extraction unit 15 extracts the first normalized topic distribution most similar to the second normalized topic distribution among a plurality of the first normalized topic distributions (step S107). The prediction unit 16 predicts power consumption of the prediction target job based on time-series data of power consumption when the job indicated by the first information corresponding to the first normalized topic distribution extracted by the extraction unit 15 is executed (step S108). The transmission unit 18 transmits the prediction data of the power consumption predicted by the prediction unit 16 to the management apparatus 2.

As described above, the prediction apparatus 1 compares the topic distributions normalized based on the predetermined rule, extracts the past job similar to the prediction target job, and predicts the power consumption of the prediction target job based on the power consumption of the extracted past job. Since the comparison target topic distributions are normalized, the prediction apparatus 1 may speed up the power consumption prediction of the job.

Since the management apparatus 2 performs the schedule setting of the job executed by the information processing apparatus 3 based on the power consumption prediction data transmitted from the prediction apparatus 1 such that the power consumption average value in the predetermined period does not exceeds the threshold.

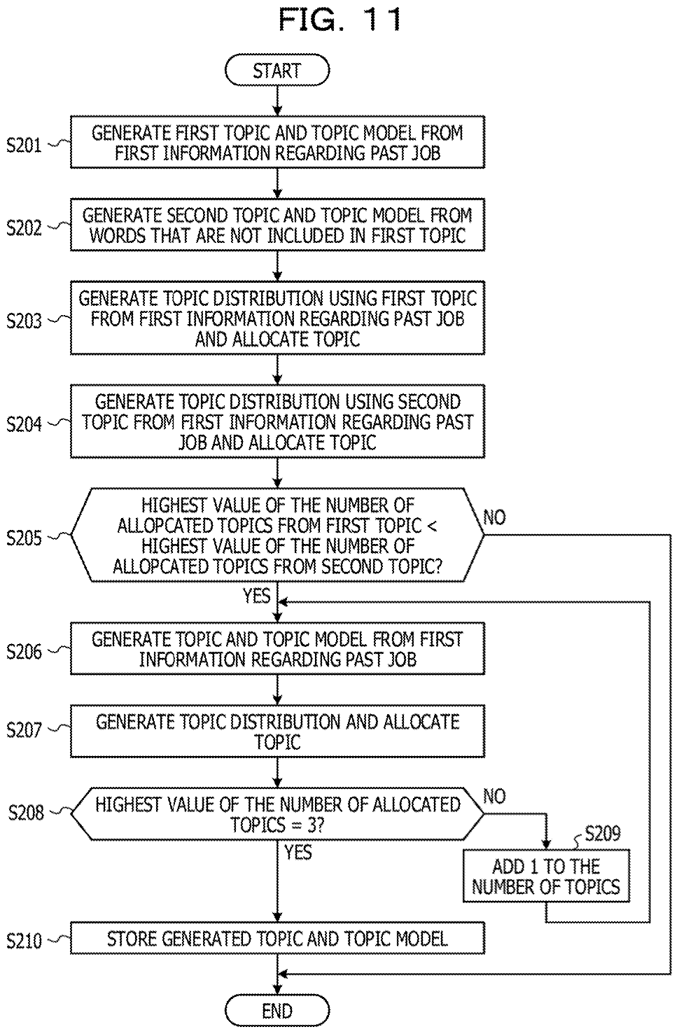

FIG. 11 is a flowchart illustrating an example of topic generation process according to the embodiment. The process illustrated in FIG. 11 is periodically executed. The topic generation unit 12 generates one or a plurality of topics (first topics) from words included in the first information regarding the past job and a topic model using the first topics (step S201). The number of topics generated in step S201 is 50, for example. The topic generation unit 12 periodically generates one or a plurality of topics (second topics) from words that are not included in the generated first topics among the words included in the first information and a topic model using the second topics (step S202).

The topic distribution generation unit 13 generates a topic distribution using a topic model using the first topic as the first information, and allocates the topic to the first information (step S203). For example, when at least one word in any topic among one or a plurality of generated first topics exists in the first information, the topic distribution generation unit 13 allocates any of the topics to the first information.

The topic generation unit 12 generates a topic distribution by using a topic model using the second topic as the first information, and allocates the topic to the first information (step S204). For example, when at least one word in any topic among one or a plurality of generated second topics exists in the first information, the topic distribution generation unit 13 allocates any of the topics to the first information.

The adjustment unit 17 determines whether or not a highest value of the number of topics allocated to the first information among the first topics is lower than a highest value of the number of topics allocated to the first information among the second topics (step S205). In the case of YES in step S205, the topic generation unit 12 generates a topic and a topic model from words included in the first information regarding a past job (step S206). An initial value of the number of topics in step S206 is set as 10, for example.

The topic distribution generation unit 13 generates a topic distribution using the topic and the topic model generated in step S206 as the first information, and allocates the topic to the first information (step S207). The adjustment unit 17 determines whether or not the highest value of the number of topics allocated to the first information is a predetermined number (for example, 3) (step S208). In the case of NO in step S208, the adjustment unit 17 adds 1 to a set value of the number of topics generated in step S206 (step S209), and returns the process in step S206.

The prediction apparatus 1 repeats the process in steps S206 to S209 until YES is determined in step S208. In the case of YES in step S208, the topic generation unit 12 stores the generated topic and topic model in the storage unit 19 (step S210). The generated latest topic and topic model are used in the process in steps S103 and S104 in FIG. 10.

When the prediction apparatus 1 periodically performs the topic generation process illustrated in FIG. 11, since appropriate topic and topic model are generated again even when a new job is added as a past job, accuracy for the power consumption prediction may be improved.

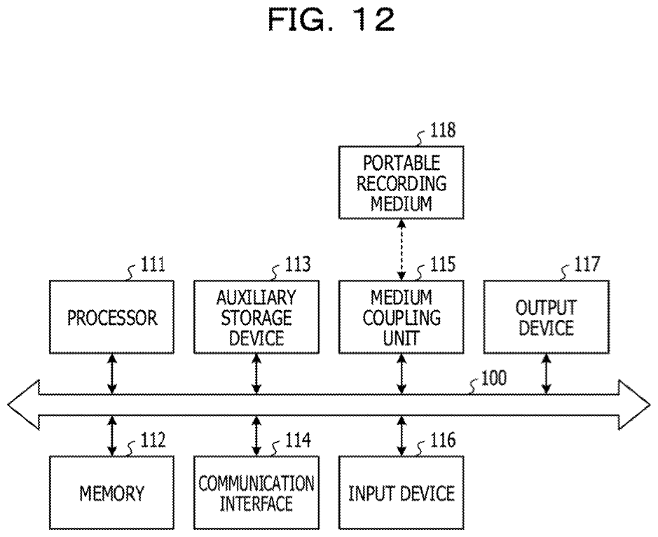

Next, an example of a hardware configuration of the prediction apparatus 1 is described. FIG. 12 is a diagram illustrating an example of a hardware configuration of the prediction apparatus 1. As illustrated in the example of FIG. 12, in the prediction apparatus 1, a processor 111, a memory 112, an auxiliary storage device 113, a communication interface 114, a medium coupling unit 115, an input device 116, and an output device 117 are coupled to a bus 100.

The processor 111 runs a program loaded in the memory 112. As the program that is run by the processor 111, a power consumption prediction program for performing the process according to the embodiment may be applied as the executed program.

The memory 112 is, for example, a random-access memory (RAM). The auxiliary storage device 113 is a storage device that stores various information, and for example, a hard disk drive, a semiconductor memory, or the like may be applied as the auxiliary storage device 113. The auxiliary storage device 113 may store the power consumption prediction program for performing the process according to the embodiment.

The communication interface 114 is coupled to a communication network such as a local area network (LAN) or a wide area network (WAN), and performs data conversion or the like involved in communication.

The medium coupling unit 115 is an interface to which a portable recording medium 118 may be coupled. An optical disc (for example, a compact disc (CD) or a digital versatile disc (DVD)), a semiconductor memory, or the like may be applied as the portable recording medium 118. The portable recording medium 118 may record the power consumption prediction program for performing the process according to the embodiment.

The input device 116 is, for example, a keyboard, a pointing device, or the like and receives inputs from users such as instructions and information. The output device 117 is, for example, a display device, a printer, a speaker, or the like, and outputs an inquiry or an instruction to a user, a processing result, and so forth.

The storage unit 19 illustrated in FIG. 4 may be implemented, for example, by the memory 112, the auxiliary storage device 113, the portable recording medium 118, or the like. The obtaining unit 11, the topic generation unit 12, the topic distribution generation unit 13, the normalization unit 14, the extraction unit 15, the prediction unit 16, the adjustment unit 17, and the transmission unit 18 illustrated in FIG. 4 may be realized when the power consumption prediction program loaded in the memory 112 is executed by the processor 111.

The memory 112, the auxiliary storage device 113, and the portable recording medium 118 are computer-readable non-transitory tangible storage media and are not temporal media such as signal carrier waves.

The prediction apparatus 1 may not include all of the constituent elements illustrated in FIG. 12, and some of the constituent elements may be omitted. Some constituent elements may be present in an external device of the prediction apparatus 1, and the prediction apparatus 1 may be coupled to the external device to utilize the constituent elements within the external device. The hardware configurations of the management apparatus 2 and the information processing apparatus 3 illustrated in FIG. 4 are the same as the configuration illustrated in FIG. 12.

The present embodiment is not limited to the embodiment described above and various modifications, additions, and exclusions may be made in a scope without departing from the gist of the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium for storing a power consumption prediction program which causes a processor to perform processing, the processing comprising:
generating a first topic distribution indicating a word appearance probability for each topic in first information regarding a job executed in a past for each first information;
generating a second topic distribution indicating a word appearance probability for each topic in second information regarding a prediction target job;
generating a first normalized topic distribution by converting the word appearance probability in the first topic distribution into a plurality of numeric values based on a predetermined rule;
generating a second normalized topic distribution by converting the word appearance probability in the second topic distribution into a plurality of numeric values based on the predetermined rule;
extracting the first normalized topic distribution most similar to the second normalized topic distribution among a plurality of the first normalized topic distributions; and
predicting power consumption of the prediction target job based on power consumption when the job indicated by the first information corresponding to the extracted first normalized topic distribution is executed.

2. The power consumption prediction program according to claim 1, the processing further comprising:
generating one or a plurality of first topics from words included in the first information, and generating one or a plurality of second topics from words that are not included in the first topics among the words;
allocating any topic among the first topics to the first information when at least one word in any topic among the one or plurality of first topics exists in the first information, and allocating any topic among the second topics to the first information when at least one word in any topic among the one or plurality of second topics exists in the first information; and
adjusting the number of topics used for generating a topic when the number of topics allocated to the first information among the first topics is lower than the number of topics allocated to the first information among the second topics, generating the topic having the adjusted number of topics, and generating a topic model used for generating the first topic distribution and the second topic distribution by using the generated topics.

3. The power consumption prediction program according to claim 2, the processing further comprising:
adjusting the number of topics used for generating the topic such that the number of topics allocated to the first information becomes a predetermined number.

4. A power consumption prediction method implemented by a computer, the power consumption prediction method comprising:
generating a first topic distribution indicating a word appearance probability for each topic in first information regarding a job executed in a past for each first information;
generating a second topic distribution indicating a word appearance probability for each topic in second information regarding a prediction target job;
generating a first normalized topic distribution by converting the word appearance probability in the first topic distribution into a plurality of numeric values based on a predetermined rule;
generating a second normalized topic distribution by converting the word appearance probability in the second topic distribution into a plurality of numeric values based on the predetermined rule;
extracting the first normalized topic distribution most similar to the second normalized topic distribution among a plurality of the first normalized topic distributions; and
predicting power consumption of the prediction target job based on power consumption when the job indicated by the first information corresponding to the extracted first normalized topic distribution is executed.

5. A power consumption prediction apparatus comprising:
a memory;
a processor coupled to the memory, the processor being configured to
execute a topic distribution generation processing that includes generating a first topic distribution indicating a word appearance probability for each topic in first information regarding a job executed in a past for each first information, and generating a second topic distribution indicating a word appearance probability for each topic in second information regarding a prediction target job;
execute a normalization processing that includes generating a first normalized topic distribution by converting the word appearance probability in the first topic distribution into a plurality of numeric values based on a predetermined rule, and generating a second normalized topic distribution by converting the word appearance probability in the second topic distribution into a plurality of numeric values based on the predetermined rule;
execute an extraction processing that includes extracting the first normalized topic distribution most similar to the second normalized topic distribution among a plurality of the first normalized topic distributions; and
execute a prediction processing that includes predicting power consumption of the prediction target job based on power consumption when the job indicated by the first information corresponding to the extracted first normalized topic distribution is executed.
